(19) United States
(12) Patent Application Publication
(10) Pub. No.: US 2009/0202691 A1
(43) Pub. Date: Aug. 13, 2009

(54) COFFEE MAKING APPARATUS AND METHOD

(76) Inventor: Derek Gauger, Ann Arbor, MI (US)

Correspondence Address: YOUNG BASILE, 3001 WEST BIG BEAVER ROAD, SUITE 624, TROY, MI, 48084, US

(21) Appl. No.: 12/028,862

(22) Filed: Feb. 11, 2008

(51) Int. Cl. A23F 5/26; A47J 31/00; A47J 31/06; B01D 29/085

(52) U.S. Cl. 426/432; 99/296; 210/473; 210/470; 210/359

(57) ABSTRACT

A coffee and brewed beverage making apparatus and method includes a coffee filter that is immersed in and removable from heated fluid in a brewing vessel. The filter has a bottom and side with mesh openings and is formed to facilitate agitation of the filter while the filter is in a brewing vessel during the brewing process, The filter is used with French press style coffee makers and both manual and automatic coffee carafes.

### BACKGROUND

There are many methods and devices for brewing or making coffee. These include drip style machines, bistro stovetop devices, vacuum style coffee makers, French (coffee) presses, and others. All such devices have limitations and compromises of different kinds when it comes to the art of brewing coffee and other flavored drinks.

In the art of brewing coffee, there are many factors that affect the flavor, strength, acidity, color, and crema of the brewed beverage. Those most noteworthy are: type and roast of the coffee beans, consistency and fineness of the grinding process, amount of coffee grounds, flavor characteristics of the water, temperature of the water, length of the brew time, and the amount of agitation during brewing. Some of these aspects of brewing coffee are not controllable by the brewing method or device such as the type and roast of the coffee beans, consistency of the grind, and the flavor characteristics of the water.

Those factors that are controllable have a substantial affect on the quality of the brewed beverage. Fineness and the amount of coffee grounds used directly affects the strength and richness of the coffee flavor. Brewing temperature is critical in that water that is too hot will burn the coffee grounds upon contact; water that is not hot enough will incompletely brew the coffee. Those skilled in the art of brewing exemplary coffee understand that 202-205 degrees F. (94.4-96.1 deg. C.) is the ideal temperature range. A longer brewing time will produce stronger coffee (desirable for some) but will increase the acidity and lead to a harsh or bitter taste. Therefore, the amount of coffee and the brew time are related aspects of the brewing process. Agitation is also related in this respect in that agitation will increase the intensity of the brewing process and will therefore decrease the brewing time needed to produce an equally strong brew. In this respect, agitation is also related directly to the amount of coffee and brew time in achieving the best brew condition. Each of the aforementioned devices and methods of making coffee have compromises and limitations in each of these controllable attributes of the brewing process.

Drip style coffee makers are the most popular and are regarded as the most convenient method of brewing coffee. These machines operate by heating a very small amount of water in a thin tube near the bottom of the device. The expanding gases from the water near or at the boiling temperature push a small amount of heated water up through a tube and into a brewing area where the coffee grounds are. Water accumulates in this brewing area and is directed through a filter and into a carafe by gravity. This method of brewing has limitations in that there is no temperature control of the water; it has lost its ideal brew temperature by the time it reaches the coffee grounds. Additionally, there is no control for brewing time, no means for agitation, and it is also limited in that if the grind is too fine the dripping water creates a cavity in the pile of grounds such that the water doesn't mix with all of the grounds but rather finds a path of least resistance through the cavity and into the carafe. Though the most popular, this type of brewing coffee is known to produce the lowest quality results.

Bistro style coffee makers are stovetop triple chamber devices. The bottom chamber is for the water supply, the middle chamber is for the coffee grounds, and the top chamber is for the brewed coffee. Heat is applied to the water through a stove burner or other heating device. The heated water is forced through a tube into and through the middle chamber; it achieves this by the expanding steam gases in the bottom chamber impeding pressure onto the water supply. The water is brewed as it passes through the brew chamber and into the top chamber. This device which is widely used in Europe, has no precise control of temperature, no control of brew time, no agitation, and is limited to the amount of coffee grounds that can be used. Additionally, the grind must be very fine as the brew time is very short. This type of coffee maker typically makes a strong brew and is known to emulate as closely as possible an espresso type coffee.

Vacuum style coffee makers work on the same principal as the bistro style coffee makers. They differ in that there are only two chambers: a water source lower chamber (which also receives the brewed coffee at the final stage of operation) and the brewing or upper chamber. Typically, modern styles of these devices have their own built in heating source. As above, the pressure from expanding steam gases during the water heating stage forces the water up a tube and into the brewing chamber where there are already coffee grounds. The grounds and heated water co-mix for an uncontrollable period of time. When the pressure in the bottom chamber is relieved from the complete heating/boiling of the water, the pressure in the top chamber along with gravity cause the brewed coffee to exit down through a filter, into the same supply tube, and finally into the bottom chamber where it accumulates as brewed coffee. Though an improvement over other methods, this device doesn't provide for brew temperature control, time control, or agitation.

The coffee or French press, a manual brewing device, is widely known as the best method for brewing coffee. It is a single chamber device in which coffee grounds and heated water co-mix for a period of time controlled by the user. When the user deems the brewing process to be over, the user operates a screen plunger assembly by affixing it to the top of the brew chamber and pushing the plunger vertical rod downwards. At the end of the plunger rod is a screen filter assembly that extends out to the inside diameter of the brew chamber. The filter assembly sweeps the inside diameter of the brew chamber and pushes the coffee grounds to the bottom of the brew chamber while allowing the brewed coffee to pass through it. This type of brewing method produces better results than the other methods because the user selects the water temperature, amount of coffee, brew time, and can provide manual agitation with another implement such as a spoon. However, the fineness of the grounds typically must be coarse as it is very difficult to plunge the filter assembly if the grind is too fine. In the case of a coarse grind, many of the coffee granules pass by the screen at the edges. In the case of a fine grind, it is not only difficult to plunge the filter but excessive force to do so causes “blow through” of the grinds as they pass through the weakest portion of the filter assembly at its edges. The same condition occurs when a large quantity of grounds are used. These conditions cause floating coarse coffee grounds in the coffee as well as a condition where the last cup or two of coffee is a mixture of coffee and coffee ground sludge. Additionally, after the plunging, the coffee grounds are in continuous contact with the brewed coffee through the filter screen. This causes the brewing process to continue until the last cup is consumed which increases the acidity and bitterness of the coffee. Users of these devices typically complain of this bitterness and pastiness of the coffee mixed with the “blown through” grounds.

What is needed is a coffee brewing method and apparatus which enables control of the controllable and critical aspects of the brewing process that are able to be controlled, including but not limited to, fineness of the coffee grounds, amount of coffee grounds, temperature of the water, brewing time, and the ability to agitate the grounds and water during the brewing process.

### SUMMARY

A coffee making method and apparatus includes a separate and removable filter capable of being agitated during the brewing process. The method and apparatus has several aspects.

In one aspect, a filter for a beverage brewing apparatus includes a mesh body having an open first end and a second end, a frame joined to the body between the first and second ends, a top surrounding the open first end of the body and means for immersing the body in a beverage brewing vessel. The immersing means also includes means for agitating the body in the beverage brewing vessel.

Ribs extend from the top along at least a portion of the body. The top may include a handle extending from the first end of the body.

The vessel may be a French or coffee press with a plunger and a top. Alternately, the vessel can be a carafe, with an optional heating element.

A method for brewing a beverage using the filter includes the steps of placing coffee grounds into the body of the filter, placing water into the brewing chamber of a vessel, heating the water to a predetermined beverage brewing temperature, and disposing the filter with the coffee grounds in the heated water. The filter with the coffee grounds is removed from the brewing chamber of the vessel after brewing is complete.

The method further includes the step of agitating the coffee grounds while the coffee grounds are disposed in the filter in the heated water. The agitating step includes translating and/or rotating the filter with the coffee grounds with respect to the brewing chamber.

A first manual aspect employs the filter which interfaces with a coffee or French press type coffee maker. In this sense, it is an improvement to, an adapter for, and a product to be used in conjunction with an already existing French press product. The mesh material contains the coffee grounds during and after brewing while allowing the brewed beverage to remain in the French press for later consumption. The filter is of sufficient size to allow ample water to be in contact with the coffee grounds during the brewing process. The process of brewing using the first manual aspect is as follows: heating water to pre-determined temperature, pre-heating the French press brewing chamber with hot water (optional), grinding coffee to selected fineness, putting a pre-selected amount of coffee grounds into the filter, dispensing the filter into the French press, pouring the heated water into the filter, agitating the grounds by moving the filter up and down or in circular motions (optional), when the brewing process is completed, removing the filter, placing the French press plunger and filter assembly onto the press and urging the press plunger down into the press (optional). The steps of disposing the filter in the press and pouring water into the press may be reversed.

A second manual aspect is identical to the first except that it does not employ the use of an existing coffee or French press. In place of the French press is a coffee carafe configured to accept the filter. The carafe may have a lid to seal the top and may be insulated to keep the brewed beverage warm. The brewing steps are identical to the first version with the exception that there is no press plunger to operate.

A semi-automatic aspect employs a heated coffee carafe or electric water kettle. The coffee carafe is capable of heating the water to and maintaining it at a temperature appropriate for coffee brewing. The steps of the brewing process are identical to those above except that the water heating occurs automatically and there is no press plunger to operate.

The disclosed coffee making method and apparatus provide for making coffee in which all of the critical elements of coffee brewing are controllable. The external filter accepts any fineness and reasonable amount of coffee grounds without leaving granules or coffee ground sludge in the coffee. Additionally, when the filter is removed from the brewed coffee, the brewing process stops completely. The time of brewing is determined by how long the operator leaves the filter in the water. The geometry of the filter is configured for easy agitation. The temperature is controlled automatically in the automatic version and manually in the manual version.

### BRIEF DESCRIPTION OF THE DRAWINGS

The various features, advantages, and other uses of the present invention will become more apparent by referring to the following detailed description and drawings in which:

FIG. 1 is a perspective view of a filter for a coffee making method and apparatus;

FIG. 2 is a side view of the filter;

FIG. 3 is a side view of a French press with filter;

FIG. 4 is an exploded side view of a French press and the filter shown in two different agitation or brewing positions;

FIG. 5 is an exploded side view of a French press with plunger above;

FIG. 6 is a side view of the French press with the plunger in the completely down position;

FIG. 7 is a side view of a coffee carafe;

FIG. 8 is a perspective view of an electric water kettle;

FIG. 9 is a perspective view of an electric water kettle base;

FIG. 10 is an exploded side view of an electric coffee carafe with the filter shown in FIGS. 1 and 2;

FIG. 11 is a side view of the electric coffee carafe with the filter in two different agitation or brewing positions;

FIG. 12 is a perspective view of an electric coffee carafe with temperature control; and

FIG. 13 is a side view of a filter with an optional handle.

### DETAILED DESCRIPTION

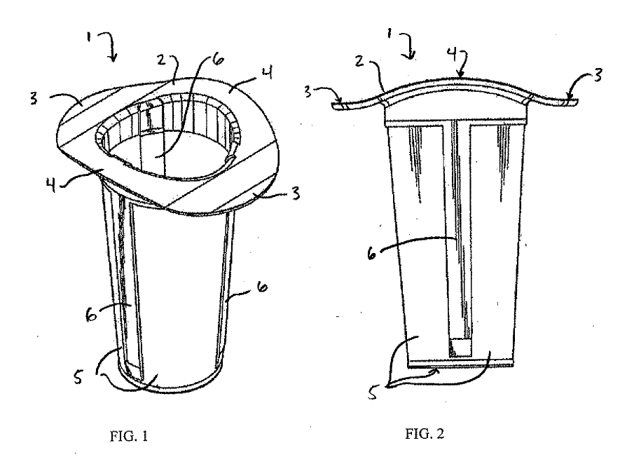

Referring to FIGS. 1-13 of the drawings, and to FIGS. 1 and 2 in particular, there is depicted a coffee brewing filter apparatus or filter 1 which is removably usable with various, different brewing chambers and devices. It will be understood that hereafter the coffee brewing filter apparatus 1 will be described for use in conjunction with specific brewing devices though it may be used with any type and geometry of brewing chamber that is capable of containing the brewed beverage. It will also be understood that while the focus of this description hereafter will be for brewing coffee, this brewing method applies to other brewed or steeped beverages such as tea and others.

As shown, the filter apparatus 1 has a body with a top 2, vertical ribs 6, and mesh openings 5. Many shapes, sizes, geometries, types of frame material, and types of mesh are possible to create a viable filter 1. Thus, forming the filter apparatus 1 by injection molding plastic over a pre-fabricated mesh cone 5 and mesh disc bottom 5 will be understood to be by example only.

The cone 5 may have a frusto-conical-shape with a tapered side which extends from a larger diameter first open end to a smaller diameter, opposed second end. The mesh disc bottom 5 is contiguous with the opposed end of the side of the cone 5. The mesh disc bottom 5 can be a separate piece from the mesh side 5 or integral with the mesh side 5. This is by example only as many other shapes are possible such as cylindrical, and those with non-circular cross sections, such as triangular, square, curvaceous shapes, etc.

There are many suitable plastic materials such as nylon, polypropylene, acetel, and other brand name specialty plastics such as Ultem, Noryl, and others that can be used for the filter 1. Additionally, there are several suitable materials for the mesh cone and mesh disc bottom 5 including stainless steel, nylon, gold plated stainless steel, and others. The mesh filter 5 can be made of mesh raw material in varying mesh characteristics rated by the size of the opening between mesh strands. The particular opening size depends on the particular application and intended coffee grind fineness.

Additionally, the top 2 of the filter apparatus 1 has a narrow side portion 4 and a wide side portion 3. The top 2 serves two purposes. The primary purpose is to provide a means for immersing the filter in a brewing vessel by providing a stopping force as the filter 1 is immersed into a brewing chamber. The secondary purpose is to provide a suitable means for a user to agitate the filter by moving it up and down or in circular or rotational patterns when in the brewing vessel. The narrow side portion 4 is used if a user prefers to provide the motion with one hand as it is narrow enough to grasp with two fingers from one hand. The wide side portion 3 enables operation with two hands and provides convenience and comfort for those users with smaller hands. Many different top shapes are possible, such as circular, polygonal, curvaceous, and these with addition of one or more tabs to facilitate ease of handling and agitation.

At least one, with a plurality, such as three, exemplary ribs 6 extend between the top 2 and the mesh disc bottom 5 of the filter apparatus 1. The one or more ribs 6 can be discreet, separate elements injection molded into the mesh cone 5 or molded as part of the top 2, with a main extent of each rib 6 extending from the top toward the mesh disc bottom 5 along the side of the mesh cone 5. The mesh disc bottom S may also having ribs extending across the bottom 5. It will be understood that other filter constructions are possible, including configurations without ribs.

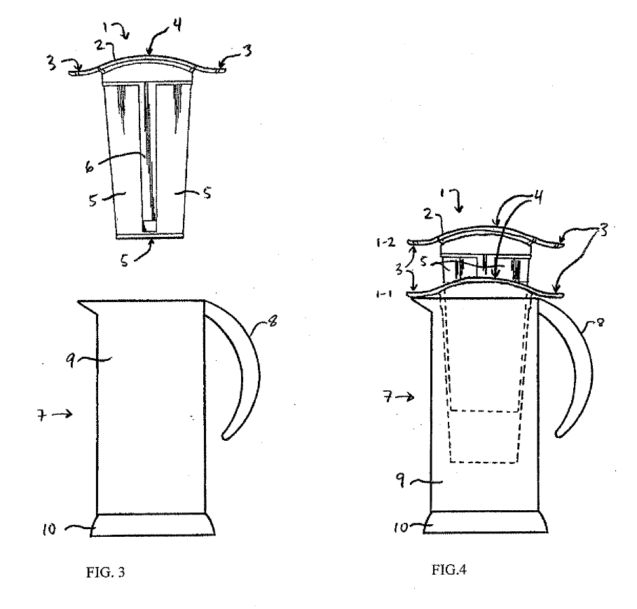

Referring to FIGS. 3-6, there is depicted the filter apparatus 1 used in conjunction with a coffee or French press coffee maker 7. FIGS. 3-6 also illustrate the process in which the filter apparatus 1 is used to brew coffee in conjunction with the French press 7. French press coffee makers come in many different configurations, shapes, sizes, and materials. For simplicity, one French press coffee maker 7 design is shown, by example. The French press 7 has a handle 8, a brewing chamber 9, a base 10, and a plunger assembly 11. The plunger assembly 11 is constructed of a top 12, a plunger handle 13 which is typically a sphere, and a plunger rod 14 which is connected to the filter screen assembly 15.

FIG. 3 depicts the initial steps in brewing coffee with a filter apparatus 1 in conjunction with the French press 7. Water is heated by a source, not shown, such as a stove or electric water kettle. The heated water can be at any temperature the user so desires to obtain the beverage flavor and strength of their liking. The coffee is ground and placed into the filter apparatus 1. The filter apparatus 1 is placed into the brewing chamber 9 of the French press 7. The water is poured into the filter 1 so as to fill the brewing chamber 9 to a level of the user's liking. It will be understood that brewing coffee in this manner, but adding the water to the French press 7 prior to inserting the filter apparatus 1 into the French press 7 is also acceptable and achieves the same results. Similarly, adding the coffee grounds into the filter apparatus 1 after it is inserted into the French press 7 also achieves the same results.

FIG. 4 depicts the brewing and agitation steps in brewing coffee with a filter apparatus 1 in conjunction with a French press 7. After the user completes the initial steps described above, the filter apparatus 1 disposed is at rest at position 1-1, with the top 2 resting on the top of the French press 7. At this time, the user may or may not agitate the filter 1 to accelerate the brewing process. One such agitation motion is vertical in nature and is includes moving the filter apparatus 1 from position 1-1 to position 1-2 and back to position 1-1 repeatedly. It will be understood that any motion of the filter apparatus 1 in any translational or rotational direction or combinations thereof will be deemed as agitation. The final step of the brewing process is for the user to remove the filter apparatus 1 from the French press 7. At this time the brewing process stops and is complete.

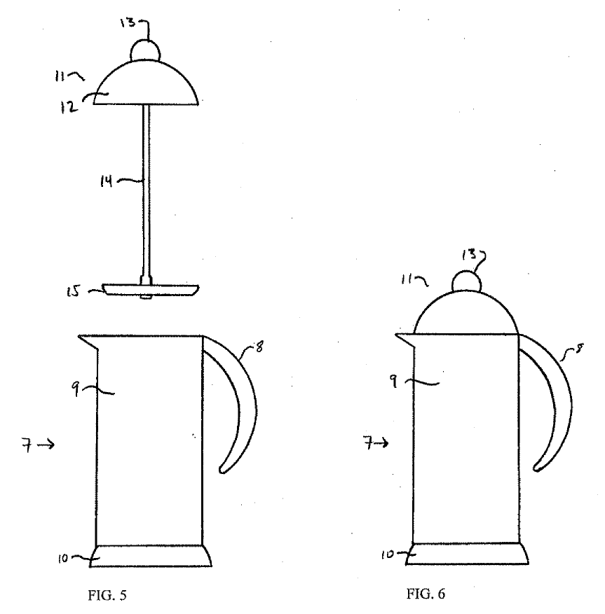

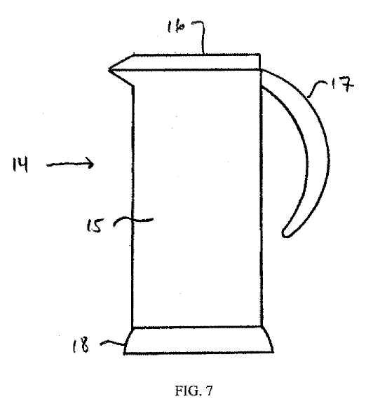

FIG. 5 shows a plunger assembly 11 for a French press 7. Though it is not necessary and does not improve the quality of the coffee, the plunger assembly 11 can be installed onto the French press 7 because it provides a top 12 that prevents spilling and retains heat. FIG. 6 shows the French press 7 with an installed plunger assembly 11.

Referring to FIG. 7, there is depicted a variation of the aforementioned brewing method and apparatus. This brewing method includes a coffee carafe device 14 that is constructed similarly to a French press 7. Like the French press 7, the coffee carafe 14 has a brew chamber 15, a handle 17, and a base 18. Different from the French press 7. The carafe 14 has a lid or top 16 that is not constructed in conjunction with a plunger assembly 11. Since the plunger assembly I 1 and the act of plunging the filter screen assembly 15 is unnecessary, the coffee carafe 14 provides a more simplified apparatus. The brewing method of the filter apparatus 1 in conjunction with the coffee carafe 14 is identical to that with the French press 7 with the exception that the operation of the plunger assembly 11 is not required; and this step is replaced by fitting the top 16 to the coffee carafe 14. Though only a simple carafe device 14 is shown, many shapes, sizes, material selections, and other attributes such as thermal insulation possible, can be employed for the carafe 14.

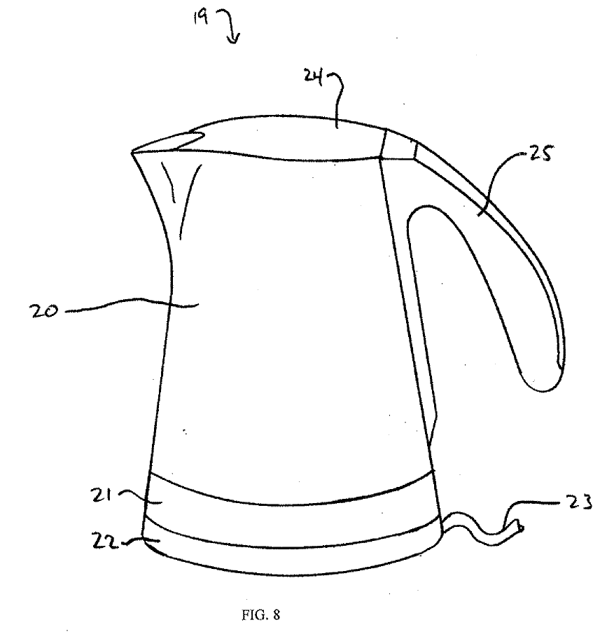

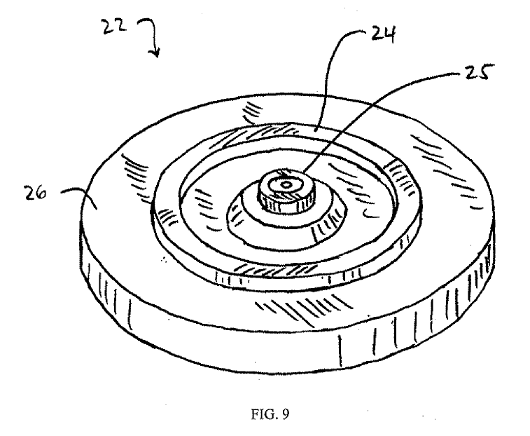

Referring to FIGS. 8-11, there is depicted another device to be used in conjunction with the filter apparatus 1. The electric coffee carafe 19 is substantially similar to an electric water kettle. Similar to an electric water kettle, the electric coffee carafe 19 has a main body with a corresponding interior cavity brew chamber 20, an electric heating lower unit 21, an electrical connection base 22, an electrical connection cord 23, a pivoting or removable lid 24, and a handle 25. The electrical connection base 22 has a main body 26, a locating ring 24, and an electrical connector 25. The electric coffee carafe 19 is easily removed from and mounted to the electrical connection base 22. The electrical connector 25 supplies electricity to a heating element in the electric heating lower unit 21.

In addition to there being many material, color, size and shape choices for the carafe 19, there are also several different types of heating elements: coil elements, thin film elements, disc element, etc. Additionally, there are many different types of overheating prevention safety devices such as bimetallic shutoff devices, thermistors, snap acting bimetallic shutoff devices, boil dry prevention devices, thermostats, and steam sensing devices, etc., that stop the operation of the heating element once an ample amount of steam is produced. There are also water level sensing devices. The electric carafe 19 may contain one or more of these components.

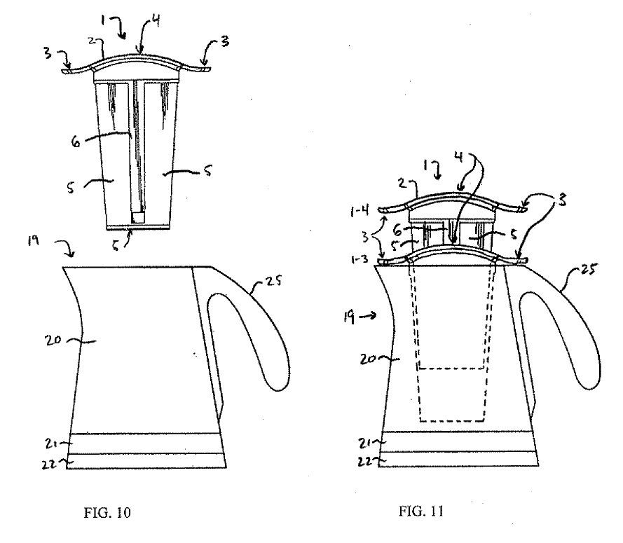

FIG. 10 depicts the initial steps in brewing coffee with a filter apparatus 1 in conjunction with the electric carafe 19. First, the user fills the electric carafe 19 with water and turns on the carafe 19. The carafe 19 then heats the water to a temperature determined by the manufacturer; but typically to the optimum brewing temperature (202-205 degrees F. or 94.4-96.1 deg. C.). The coffee is ground and placed into the filter apparatus 1. The filter apparatus 1 is placed into the brew chamber 20 of the electric coffee carafe 19. It will be understood that brewing coffee this way, but adding the coffee grounds into the filter apparatus 1 after it is inserted into the electric coffee carafe 19 achieves the same results. Additionally, it is the user's choice to insert the coffee grounds and the filter apparatus 1 in the electric coffee carafe prior to turning on the electric coffee carafe 19.

FIG. 11 depicts the brewing and agitation steps in brewing coffee with a filter apparatus 1 in conjunction with the electric coffee carafe 19. After the user completes the steps described above, the filter apparatus 1 disposed is at rest at position 1-3 with the top 2 resting on the top of the electric coffee carafe 19. At this time, the user may or may not agitate the filter to accelerate the brewing process. One such agitation motion is vertical in nature and is described by moving the filter apparatus 1 repeatedly from position 1-3 to position 1-4 and back to position 1-3. It will be understood that any motion of the filter apparatus 1 in any translational or rotational direction will be deemed as agitation. The final step of the brewing process is for the user to remove the filter apparatus 1 from the electric coffee carafe 19. At this time the brewing process stops and is complete.

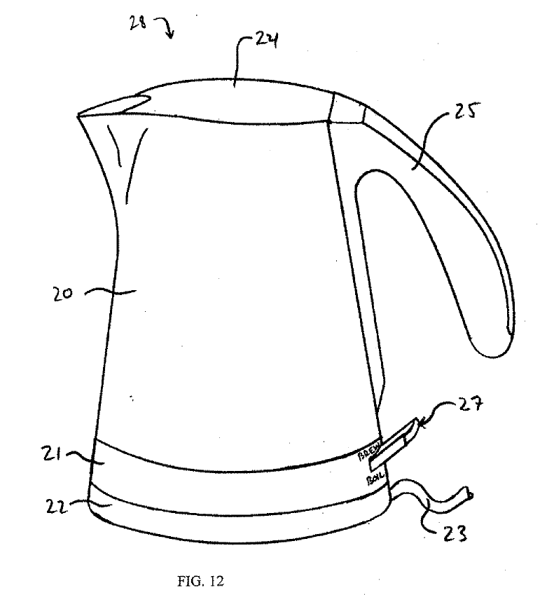

Referring now to FIG. 12, there is depicted another aspect of the electric coffee or electric carafe 28 with a dual temperature control with a temperature selector switch 27. This switch 27 employs a snap acting bimetallic actuator. When the carafe 28 is on the electrical connection base 22, the user turns on the carafe by placing the switch 27 to the “on” position. This engages a snap acting bimetallic actuator that, in turn, supplies electricity to a heating element in the carafe 19. When the carafe 28 heats the water to the temperature pre-determined by the characteristics of the bimetallic actuator, the actuator opens the electrical circuit and automatically snaps the switch 27 to the “off” position. The electric coffee carafe 28 with dual temperature control uses a temperature selector/on-off switch 27 with three positions: “off”, “on” for boiling water, and “on” for brewing coffee. When the user places the switch 27 in the “on” for brewing coffee position, the switch 27 engages one snap acting bimetallic actuator that actuates and opens the electrical circuit to the heating element once the water reaches the optimum coffee brewing temperature. When the user places the switch in the “boil” position, it engages a different snap acting bimetallic actuator that actuates and opens the electrical circuit to the heating element only after the water has reached its boiling state. This provides for a carafe 28 with a multiplicity of purposes. Since it is not desirable to brew coffee with boiling water but it may be desirable to boil water for other purposes, the carafe 28 is useful for a multitude of purposes.

Other additional attributes of the electric coffee carafes 19 and 28 that are not shown include automatic agitation system through a water movement device, a sound signal to indicate that the water has reached the brewing temperature, a water temperature display, a user selected temperature control, clock and pre-set turn-on times device, and a geometry of the top portion of the device that conforms to the shape of the filter apparatus 1.

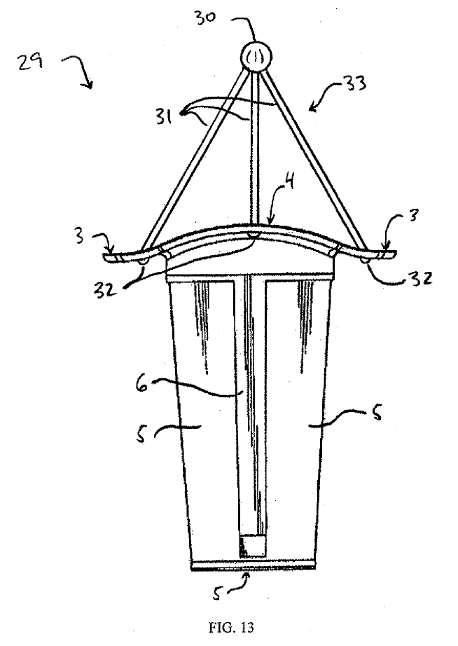

Referring to FIG. 13, there is depicted another aspect of the filter apparatus 1. This filter apparatus with handle 29 is identical to the filter apparatus 1 except it has the addition of a handle 33. The handle 33 provides another means for providing agitation during the brewing process. The handle 33 has a finger ball 30, legs 31, and attachment means 32 by which the handle 33 connects to the filter apparatus 1. The handle 33 is made of multi-piece or single piece plastic or another suitable material. The attachment means 32 can be a plurality of semi-spheres or fingers slightly larger in diameter than a corresponding aperture 35 in the top of the filter apparatus 1. The attachment means 32 are pressed into and through the apertures 34. Other attachment means are possible such as vibration welding, heat staking, and other methods.

What is claimed is:

1. A filter for a beverage brewing vessel comprising:
a mesh body having an open first end and a second end;
a frame joined to the body; and
means carried on the body, adapted for immersing the body in a beverage brewing vessel.

2. The filter of claim 1 wherein the frame comprises:
at least one rib extending along at least a portion of the body.

3. The filter of claim 1 further comprising:
a top surrounding the open first end of the body,

4. The filter of claim 3 wherein the top comprises:
a handle extending from the first end of the body.

5. The filter of claim 3 wherein the immersing means comprises:
the top having a first narrow side portion and a second wide side portion.

6. The filter of claim 1 wherein the immersing means further comprises:
means for facilitating agitation of the body when the body is disposed in a beverage brewing vessel.

7. A method for brewing a beverage using the filter of claim 1 comprising the steps of:
placing coffee grounds into the body of the filter;
placing water into a vessel;
heating the water to a predetermined beverage brewing temperature; and
immersing the filter in the heated water.

8. The method of claim 7 further comprising the step of:
removing the filter with the coffee grounds from the brewing chamber of the vessel.

9. The method of claim 7 further comprising the step of:
agitating the coffee grounds while the coffee grounds are disposed in the heated water.

10. The method of claim 9 wherein the step of agitating comprises the step of:
rotating the filter with the grounds with respect to the brewing chamber.

11. The method of claim 9 wherein the step of agitating comprises:
translating the filter with the grounds with respect to the brewing chamber.

12. A beverage brewing apparatus comprising:
a vessel adapted to receive a fluid;
a mesh body having an open first end and a second end;
a frame joined to the body; and
means carried on the body, adapted for immersing the body in a beverage brewing vessel.

13. The apparatus of claim 12 wherein the frame further comprise:
ribs extending along at least a portion of the body.

14. The beverage brewing apparatus of claim 12 further comprising:
a top surrounding the open first end of the body.

15. The apparatus of claim 14 wherein the top comprises:
a handle extending from the first end of the body.

16. The apparatus of claim 12 wherein:
the top including a first narrow side portion and a second wide side portion.

17. The apparatus of claim 12 wherein:
the vessel is one of a coffee press and French press.

18. The apparatus of claim 17 wherein the one of the coffee press and the French press comprises:
a plunger and a top.

19. The apparatus of claim 12 wherein:
the vessel is a carafe.

20. The apparatus of claim 19 wherein a carafe further comprises:
a heating element.

21. The apparatus of claim 12 wherein the immersing means further comprises:
means for facilitating agitation of the body when the body is disposed in a beverage brewing vessel.

22. A method for brewing a beverage comprising the steps of:
placing coffee grounds into a body of a filter;
placing water into a vessel;
heating the water to a predetermined beverage brewing temperature; and
immersing the filter in the heated water.

23. The method of claim 22 further comprising the step of:
removing the filter with the coffee grounds from the brewing chamber of the vessel.

24. The method of claim 22 further comprising the step of:
agitating the coffee grounds while the coffee grounds are disposed in the heated water.

25. The method of claim 24 wherein the step of agitating comprises the step of:
rotating the filter with the grounds with respect to the brewing chamber.

26. The method of claim 24 wherein the step of agitating comprises the step of:
translating the filter with the grounds with respect to the brewing chamber.
